(19) United States
(12) Patent Application Publication
(10) Pub. No.: US 2023/0322119 A1
(43) Pub. Date: Oct. 12, 2023

(54) Charging And Patrol Replacement System For Air-Land Unmanned Aerial Vehicles And Method Thereof

(71) Applicants: SQ Technology (Shanghai) Corporation, Shanghai (CN); Inventec Corporation, Taipei City (TW)

(72) Inventors: Chuan-Cheng Chiu, Taipei City (TW); Miao-Miao Liu, Shanghai (CN); Zhi-Dong Zhang, Shanghai (CN)

(21) Appl. No.: 17/843,808

(22) Filed: Jun. 17, 2022

(30) Foreign Application Priority Data
Mar. 24, 2022 (CN) 202210295282.7

(51) Int. Cl. G05D 1/12; B60L 53/68; B64C 39/02; B60L 53/12

(52) U.S. Cl. CPC B60L 53/68; B60L 53/12; B64C 39/024; G05D 1/12; B64C 2201/12; B64C 2201/146

(57) ABSTRACT

A charging and patrol replacement system for air-land unmanned aerial vehicles and a method thereof. In the system, an unmanned aerial vehicle in flight continuously detects a remaining battery power thereof, and when the remaining battery power is lower than a threshold, the unmanned aerial vehicle generates and transmits a return-to-home signal to an unmanned ground vehicle, the unmanned ground vehicle continuously transmits a coordinate of a power supply vehicle to the unmanned aerial vehicle in flight, to guide the unmanned aerial vehicle in flight to return to the power supply vehicle for charging, and the unmanned ground vehicle then activates another unmanned aerial vehicle to synchronize patrol data with the unmanned aerial vehicle which is returned to charge, so as to replace the returned unmanned aerial vehicle to perform patrol, thereby achieving the technical effect of improving the sustainability and synergy of the air-land unmanned vehicles.

### CROSS-REFERENCE TO RELATED APPLICATION

This application claims the benefit of Chinese Application Serial No. 202210295282.7, filed Mar. 24, 2022, which is hereby incorporated herein by reference in its entirety.

### BACKGROUND OF THE INVENTION

### 1. Field of the Invention

The present invention relates to a charging and patrol replacement system and a method thereof, and more particularly to a charging and patrol replacement system for air-land unmanned aerial vehicles and a method thereof.

### 2. Description of the Related Art

In recent years, with the popularity and vigorous development of unmanned aerial vehicle, various unmanned aerial vehicles based applications have sprung up, such as patrol, pesticide spraying, environmental measurement and so on. However, due to the limited battery capacity of the unmanned aerial vehicle, the unmanned aerial vehicle (such as a quadcopter drone) can only fly for about 30 minutes. How to improve the battery life and sustainability of the unmanned aerial vehicle has become one of key issues for manufacturers.

In general, the conventional unmanned aerial vehicle usually uses one of two power sources including battery and fuel, and in order to make the unmanned aerial vehicle have more long-term airborne capability, the conventional unmanned aerial vehicle is often designed to have more battery capacity or carry more fuel, but the above-mentioned conventional methods greatly increase the weight and volume of the unmanned aerial vehicle and adversely affect the sustainability of the unmanned aerial vehicle. Therefore, the conventional unmanned aerial vehicle system has a problem of poor sustainability.

In view of this, some manufacturers have proposed a fuel-electric hybrid manner of combining fuel and battery, and the fuel-electric hybrid manner automatically uses one of the two power sources in different situations, for example, the unmanned aerial vehicle can use fuel as the power source at night and use battery as the power source during the day, and the unmanned aerial vehicle can be equipped with solar panels to charge the battery, so as to increase the battery life of the unmanned aerial vehicle. However, when an unmanned aerial vehicle runs out of power, it needs to use another unmanned aerial vehicle to take over the task of the power-exhausted unmanned aerial vehicle, but the take-over operation requires a manual operation for multiple unmanned aerial vehicles, and it easily causes the problem of poor synergy.

According to above-mentioned contents, what is needed is to develop an improved solution to solve the conventional technology problem of poor sustainability and synergy of the air-land unmanned vehicles.

### SUMMARY OF THE INVENTION

An objective of the present invention is to disclose a charging and patrol replacement system for air-land unmanned aerial vehicles and a method thereof, so as to solve the conventional problem.

In order to achieve the objective, the present invention discloses a charging and patrol replacement system for air-land unmanned aerial vehicles, and the charging and patrol replacement system includes a plurality of unmanned aerial vehicles and an unmanned ground vehicle. Each of the plurality of the unmanned aerial vehicles includes a detection module, a transceiver module, a navigation module and a synchronization module. The unmanned ground vehicle includes a control module and a transmission module. When the unmanned aerial vehicle is in flight, the detection module generates patrol data through at least one sensor and continuously detect a remaining battery power thereof, and when the remaining battery power is lower than a threshold, the detection module generates a return-to-home signal. The transceiver module is connected to the detection module, and configured to transmit the generated patrol data and the return-to-home signal, receive a control signal for controlling the flight of the unmanned aerial vehicle, and receive a coordinate of a power supply vehicle having a charging module. The navigation module is connected to the transceiver module and configured to execute a return-to-home program based on the coordinate of the power supply vehicle, wherein the return-to-home program is executed to calculate a distance between a coordinate of the unmanned aerial vehicle in flight and the coordinate of the power supply vehicle, and the navigation module guides the unmanned aerial vehicle in flight to reach and land on the power supply vehicle having a shortest distance from the unmanned aerial vehicle in flight, to electrically connect to the charging module for charging. The synchronization module is connected to the navigation module. When the unmanned aerial vehicle executes the return-to-home program, the synchronization module transmits the patrol data to another activated unmanned aerial vehicle to complete data synchronization, so that the another activated unmanned aerial vehicle replaces the unmanned aerial vehicle, which is executing the return-to-home program, to perform patrol based on the patrol data. The control module is configured to generate the control signal for controlling the flight of the unmanned aerial vehicle, and select one of the plurality of unmanned aerial vehicle to activate, wherein when the unmanned ground vehicle detects that the selected one of the unmanned aerial vehicle is executing the return-to-home program, the unmanned ground vehicle selects another one of the plurality of unmanned aerial vehicle to activate. The transmission module is connected to the control module and configured to continuously transmit the control signal to the selected unmanned aerial vehicle, wherein when receiving the return-to-home signal from the unmanned aerial vehicle in flight, the transmission module transmits the coordinate of the power supply vehicle to the unmanned aerial vehicle in flight.

In order to achieve the objective, the present invention discloses a charging and patrol replacement method for air-land unmanned aerial vehicles, and the charging and patrol replacement method includes is applied to environment where a plurality of unmanned aerial vehicles and an unmanned ground vehicle are disposed, wherein the charging and patrol replacement method includes steps of: selecting and activating one of the plurality of unmanned aerial vehicles and continuously transmitting a control signal to the selected unmanned aerial vehicle to control a flight of the selected unmanned aerial vehicle, by the unmanned ground vehicle; continuously generating patrol data through at least one sensor, continuously detecting a remaining battery power of the unmanned aerial vehicle in flight, and generating and transmitting a return-to-home signal to the unmanned ground vehicle when the remaining battery power is lower than a threshold, by the unmanned aerial vehicle in flight; when the unmanned ground vehicle receives the return-to-home signal, transmitting a coordinate of a power supply vehicle having a charging module, to the unmanned aerial vehicle in flight; executing a return-to-home program based on the received coordinate of the power supply vehicle, by the unmanned aerial vehicle in flight, wherein the return-to-home program is executed to calculate a distance between the coordinate of the unmanned aerial vehicle in flight and the coordinate of the power supply vehicle, to guide the unmanned aerial vehicle in flight to reach and land on the power supply vehicle having a shortest distance therefrom, and to electrically connect to the charging module for charging; when the unmanned ground vehicle detects that the unmanned aerial vehicle is executing the return-to-home program, selecting and activating another one of the unmanned aerial vehicle, and transmitting a control signal to the selected unmanned aerial vehicle to control and select another unmanned aerial vehicle to fly, by the unmanned ground vehicle; transmitting the patrol data to the another activated unmanned aerial vehicle to complete data synchronization, by the unmanned aerial vehicle executing the return-to-home program, wherein the another activated unmanned aerial vehicle replaces the unmanned aerial vehicle, which is executing the return-to-home program, to perform patrol based on the patrol data.

According to the above-mentioned system and method of the present invention, the difference between conventional technology and the present invention is that, in the present invention, the unmanned aerial vehicle in flight continuously detects the remaining battery power thereof, and when the remaining battery power is lower than the threshold, the unmanned aerial vehicle generates and transmits the return-to-home signal to the unmanned ground vehicle, the unmanned ground vehicle continuously transmits the coordinate of the power supply vehicle to the unmanned aerial vehicle in flight, to guide the unmanned aerial vehicle in flight to return to the power supply vehicle for charging, and the unmanned ground vehicle then activates the another unmanned aerial vehicle to synchronize patrol data with the unmanned aerial vehicle which is returned to charge, so as to replace the returned unmanned aerial vehicle to perform patrol.

Therefore, the above-mentioned technical solution of the present invention is able to achieve the technical effect of improving the sustainability and synergy of the air-land unmanned vehicles.

### BRIEF DESCRIPTION OF THE DRAWINGS

The structure, operating principle and effects of the present invention will be described in detail by way of various embodiments which are illustrated in the accompanying drawings.

FIG. 1 is a system block diagram a charging and patrol replacement system for air-land unmanned aerial vehicles, according to the present invention.

FIGS. 2A to 2C are flowcharts of a charging and patrol replacement method for air-land unmanned aerial vehicles, according to the present invention.

FIG. 3 is a schematic view of an operation to perform charging operation and patrol replacement, according to the present invention.

FIG. 4 is a schematic view of an operation of moving an unmanned aerial vehicle to a backup power-supply vehicle for charging, according to an application of the present invention.

### DETAILED DESCRIPTION OF THE PREFERRED EMBODIMENTS

The following embodiments of the present invention are herein described in detail with reference to the accompanying drawings. These drawings show specific examples of the embodiments of the present invention. These embodiments are provided so that this disclosure will be thorough and complete, and will fully convey the scope of the invention to those skilled in the art. It is to be acknowledged that these embodiments are exemplary implementations and are not to be construed as limiting the scope of the present invention in any way. Further modifications to the disclosed embodiments, as well as other embodiments, are also included within the scope of the appended claims.

These embodiments are provided so that this disclosure is thorough and complete, and fully conveys the inventive concept to those skilled in the art. Regarding the drawings, the relative proportions and ratios of elements in the drawings may be exaggerated or diminished in size for the sake of clarity and convenience. Such arbitrary proportions are only illustrative and not limiting in any way. The same reference numbers are used in the drawings and description to refer to the same or like parts. As used herein, the singular forms “a”, “an” and “the” are intended to include the plural forms as well, unless the context clearly indicates otherwise. As used herein, the term “or” includes any and all combinations of one or more of the associated listed items.

It will be acknowledged that when an element or layer is referred to as being “on,” “connected to” or “coupled to” another element or layer, it can be directly on, connected or coupled to the other element or layer, or intervening elements or layers may be present. In contrast, when an element is referred to as being “directly on,” “directly connected to” or “directly coupled to” another element or layer, there are no intervening elements or layers present.

In addition, unless explicitly described to the contrary, the words “comprise” and “include”, and variations such as “comprises”, “comprising”, “includes”, or “including”, will be acknowledged to imply the inclusion of stated elements but not the exclusion of any other elements.

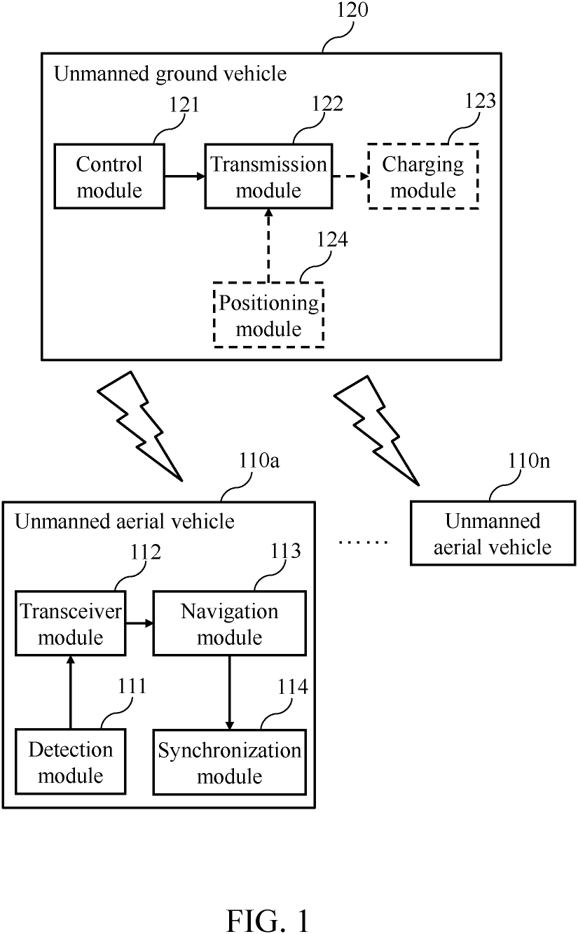

Please refer to FIG. 1, which is a system block diagram a charging and patrol replacement system for air-land unmanned aerial vehicles, according to the present invention. As shown in FIG. 1, the charging and patrol replacement system includes unmanned aerial vehicles 110a~110n, and an unmanned ground vehicle 120. Each of the unmanned aerial vehicles 110a~110n includes a detection module 111, a transceiver module 112, a navigation module 113 and a synchronization module 114. When each of the unmanned aerial vehicles 110a~110n is in flight, the detection module 111 uses at least one sensor to generate patrol data and continuously detects a remaining battery power thereof, and when the remaining battery power is lower than a threshold, the detection module 111 generates a return-to-home signal. In actual implementation, the at least one sensor can include at least one of various sensors including an infrared sensor, a laser sensor, an image sensor, a sound sensor, a pneumatic sensor, a voltage sensor, a current sensor, to generate the patrol data and detect the remaining battery power of the battery.

The transceiver module 112 is connected to the detection module 111 and configured to transmit the generated patrol data and a return-to-home signal, and receive a control signal for controlling the flight of the unmanned aerial vehicle, and a coordinate of a power supply vehicle having a charging module. In actual implementation, the charging module can include a wireless charging platform and an automatic landing-guidance system; when being landing on a wireless charging platform, one of the unmanned aerial vehicles 110a~110n can continuously receive flight parameters transmitted from the automatic landing-guidance system, so that the one of the unmanned aerial vehicles 110a~110n is guided to align a central point of a wireless charging platform based on the flight parameters, a flight posture of the one of the unmanned aerial vehicles 110a~110n is adjusted based on the flight parameters. In an embodiment, the charging module can include a magnetic charging component, when one of the unmanned aerial vehicles 110a~110n lands on the power supply vehicle, a magnetic connector disposed on a bottom of mounting frame of the one of the unmanned aerial vehicles 110a~110n can be electrically connect to the magnetic charging component for charging.

The navigation module 113 is connected to the transceiver module 112 and configured to execute a return-to-home program based on the received coordinate of the power supply vehicle. The return-to-home program calculates a distance between the coordinate of the unmanned aerial vehicle in flight and the coordinate of the power supply vehicle, and guide the unmanned aerial vehicles in flight to reach and land on the power supply vehicle having a shortest distance therefrom, so as to electrically connect to the charging module of the power supply vehicle for charging. In actual implementation, a shortest distance between two coordinate can be calculated by a shortest path algorithm, Dijkstra Algorithm, or K Shortest Path (KSP), or other similar algorithm.

The synchronization module 114 is connected to the navigation module 113, and when one of the unmanned aerial vehicles 110a~110n executes the return-to-home program, the synchronization module 114 of the one of the unmanned aerial vehicles 110a~110n transmits the patrol data to another activated one of the unmanned aerial vehicles 110a~110n, to complete data synchronization therebetween, the another activated one of the unmanned aerial vehicles 110a~110n replaces the one of the unmanned aerial vehicles 110a~110n executing the return-to-home program, to perform patrol based on the patrol data. In actual implementation, the data synchronization can be in cooperation with key signature and verification technology to encrypt and decrypt the patrol data, so as to prevent the patrol data from being tampered.

The unmanned ground vehicle 120 includes a control module 121 and a transmission module 122. The control module 121 is configured to generate a control signal for controlling the flight of one of the unmanned aerial vehicles 110a~110n, and activate another one of the unmanned aerial vehicles 110a~110n. When the unmanned ground vehicle 120 detects that the one of the unmanned aerial vehicles 110a~110n is executing the return-to-home program, the control module 121 selects and activates another one of the plurality of unmanned aerial vehicles 110a~110n. For example, in a condition that the unmanned aerial vehicle 110a is activated first, when the unmanned ground vehicle 120 detects that the unmanned aerial vehicle 110a is executing the return-to-home program, the unmanned aerial vehicle 110b is selected to activate.

The transmission module 122 is connected to the control module 121 and configured to continuously transmit the control signal to the selected one of the unmanned aerial vehicles 110a~110n, when the transmission module 122 receives the return-to-home signal from one of the unmanned aerial vehicles 110a~110n, the transmission module 122 transmits the coordinate of the power supply vehicle to the one of the unmanned aerial vehicles 110a~110n in flight. In actual implementation, the transmission module 122 can transmit the control signal and the return-to-home signal through wireless communication technology such as wireless network, cell network, short-range P2P communication, or wireless sensor network. In addition, the coordinate of the power supply vehicle can be pre-stored in the unmanned ground vehicle 120 or obtained in real time from the positioning system.

The unmanned ground vehicle 120 can include the charging module 123 and a positioning module 124. When the unmanned ground vehicle 120 receives the return-to-home signal, the unmanned ground vehicle 120 enables the charging module 123 disposed on the unmanned ground vehicle 120, so that the unmanned ground vehicle 120 becomes the power supply vehicle, obtains the coordinate (such as longitude and latitude) of the power supply vehicle from the positioning module 124 and continuously transmits the coordinate to the unmanned aerial vehicle executing the return-to-home program. In actual implementation, the positioning module 124 can be implemented by the global positioning system, BeiDou Navigation Satellite System (BDS), Galileo positioning system, GLONASS positioning system, or other similar positioning system. The operation of the charging module 123 can refer to above-mentioned illustration, so detailed description is not repeated herein.

It is to further explain that the system of the present invention can include a plurality of backup power-supply vehicles, each of the plurality of backup power-supply vehicles is disposed on a patrol area and obtain a positioning coordinate from the positioning system, when the unmanned aerial vehicle in flight transmits the return-to-home signal but does not receive a coordinate of the power supply vehicle transmitted from the unmanned ground vehicle after a waiting time, the unmanned aerial vehicle in flight can broadcast a charging request, when one of the backup power-supply vehicles receives the charging request, the one of the backup power-supply vehicles broadcasts the positioning coordinate thereof, so that the unmanned aerial vehicle in flight can receive and use the positioning coordinate as the coordinate of the power supply vehicle, and execute the return-to-home program, based on the received coordinate of the power supply vehicle. The above-mentioned operation will be illustrated in detail with reference to the accompanying drawings.

It is to be particularly noted that, in actual implementation, the modules of the present invention can be implemented by various manners, including software, hardware or any combination thereof, for example, in an embodiment, the module can be implemented by software and hardware, or one of software and hardware. Furthermore, the present invention can be implemented fully or partly based on hardware, for example, one or more module of the system can be implemented by integrated circuit chip, system on chip (SOC), a complex programmable logic device (CPLD), or a field programmable gate array (FPGA). The concept of the present invention can be implemented by a system, a method and/or a computer program. The computer program can include computer-readable storage medium which records computer readable program instructions, and the processor can execute the computer readable program instructions to implement concepts of the present invention. The computer-readable storage medium can be a tangible apparatus for holding and storing the instructions executable of an instruction executing apparatus Computer-readable storage medium can be, but not limited to electronic storage apparatus, magnetic storage apparatus, optical storage apparatus, electromagnetic storage apparatus, semiconductor storage apparatus, or any appropriate combination thereof. More particularly, the computer-readable storage medium can include a hard disk, an RAM memory, a read-only-memory, a flash memory, an optical disk, a floppy disc or any appropriate combination thereof, but this exemplary list is not an exhaustive list. The computer-readable storage medium is not interpreted as the instantaneous signal such a radio wave or other freely propagating electromagnetic wave, or electromagnetic wave propagated through waveguide, or other transmission medium (such as optical signal transmitted through fiber cable), or electric signal transmitted through electric wire. Furthermore, the computer readable program instruction can be downloaded from the computer-readable storage medium to each calculating/processing apparatus, or downloaded through network, such as internet network, local area network, wide area network and/or wireless network, to external computer equipment or external storage apparatus. The network includes copper transmission cable, fiber transmission, wireless transmission, router, firewall, switch, hub and/or gateway. The network card or network interface of each calculating/processing apparatus can receive the computer readable program instructions from network, and forward the computer readable program instruction to store in computer-readable storage medium of each calculating/processing apparatus. The computer program instructions for executing the operation of the present invention can include source code or object code programmed by assembly language instructions, instruction-set-structure instructions, machine instructions, machine-related instructions, micro instructions, firmware instructions or any combination of one or more programming language. The programming language include object oriented programming language, such as Common Lisp, Python, C++, Objective-C, Smalltalk, Delphi, Java, Swift, C#, Perl, Ruby, and PHP, or regular procedural programming language such as C language or similar programming language. The computer readable program instruction can be fully or partially executed in a computer, or executed as independent software, or partially executed in the client-end computer and partially executed in a remote computer, or fully executed in a remote computer or a server.

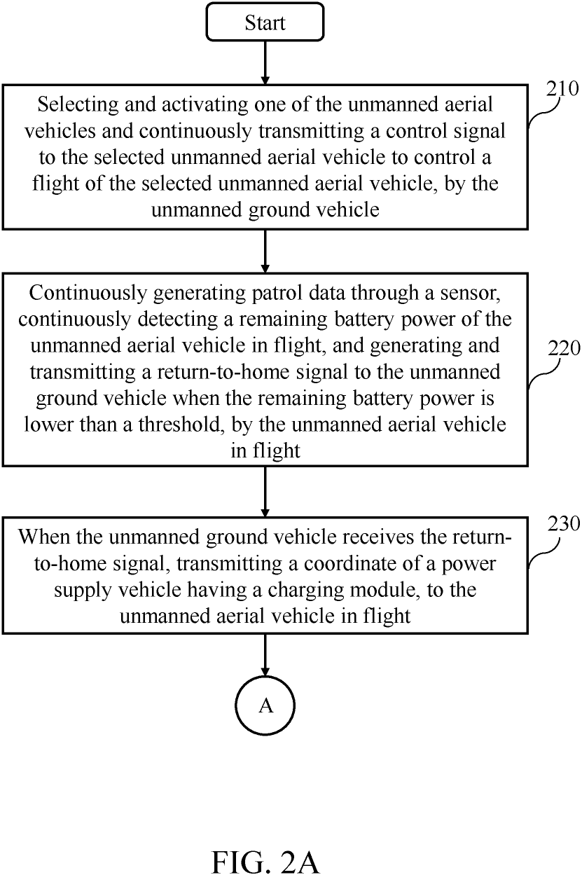

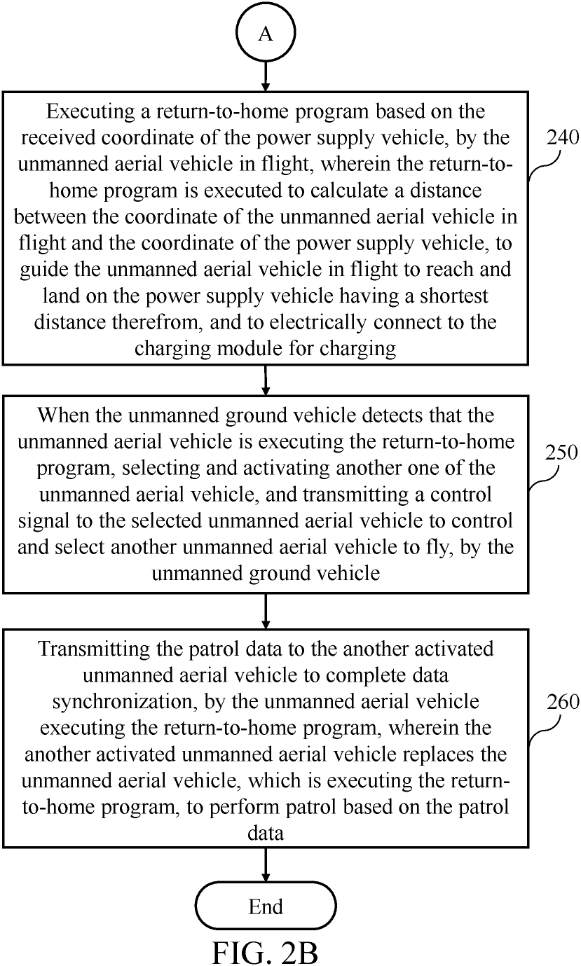

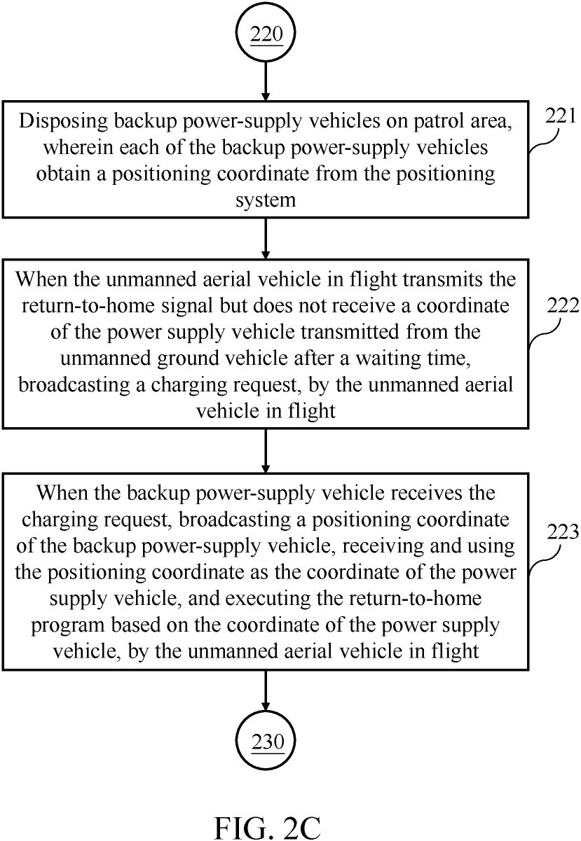

Please refer to FIGS. 2A to 2C, which are flowcharts of a charging and patrol replacement method for air-land unmanned aerial vehicles, according to the present invention. The charging and patrol replacement method is applied to environment where unmanned aerial vehicles 110a~110n and an unmanned ground vehicle 120 are disposed, and includes the following steps. In a step 210, one of the unmanned aerial vehicles 110a~110n is selected to activate by the unmanned ground vehicle 120, and a control signal is continuously transmitted to the selected one of the unmanned aerial vehicles 110a~110n, to control a flight of the selected one of the unmanned aerial vehicles 110a~110n. In a step 220, the unmanned aerial vehicles 110a~110n in flight uses a sensor to continuously generate patrol data and continuously detects a remaining battery power thereof, and when the remaining battery power is lower than a threshold, a return-to-home signal is generated and transmitted to the unmanned ground vehicle 120. In a step 230, when the unmanned ground vehicle 120 receives the return-to-home signal, the unmanned ground vehicle 120 transmits a coordinate of a power supply vehicle having a charging module, to the unmanned aerial vehicle in flight. In a step 240, the one of the unmanned aerial vehicles 110a~110n in flight executes a return-to-home program based on the received coordinate of the power supply vehicle, and the return-to-home program calculates a distance between the coordinate of the unmanned aerial vehicle in flight and the coordinate of the power supply vehicle, to guide the one of the unmanned aerial vehicles 110a~110n in flight to reach and land on the power supply vehicle having a shortest distance from the one of the unmanned aerial vehicles 110a~110n, to electrically connect to the charging module for charging. In a step 250, when the unmanned ground vehicle 120 detects that one of the unmanned aerial vehicles 110a~110n is executing the return-to-home program, the unmanned ground vehicle 120 selects another one of the unmanned aerial vehicles 110a~110n to activate, and transmits a control signal to the selected one of the unmanned aerial vehicles 110a~110n, so as to control the selected one of the unmanned aerial vehicles 110a~110n to fly. In a step 260, the one of the unmanned aerial vehicles 110a~110n executing the return-to-home program transmits the patrol data to the another activated one of the unmanned aerial vehicles 110a~110n to complete data synchronization, so that the another activated one of the unmanned aerial vehicles 110a~110n can replace the one of the unmanned aerial vehicles 110a~110n executing the return-to-home program to perform patrol based on the patrol data. In a step 270, one of the unmanned aerial vehicles 110a~110n in flight continuously detects the remaining battery power thereof, and when the remaining battery power is lower than a threshold, the one of the unmanned aerial vehicles 110a~110n in flight generates and transmits a return-to-home signal to the unmanned ground vehicle 120, the unmanned ground vehicle 120 continuously transmits a coordinate of the power supply vehicle to the one of the unmanned aerial vehicles 110a~110n in flight, to guide the one of the unmanned aerial vehicles 110a~110n in flight to return to the power supply vehicle for charging, and another one of the unmanned aerial vehicles 110a~110n is activated at the same time to perform patrol data synchronization with the one of the unmanned aerial vehicles 110a~110n which is returned to charge, so that the another activated one of the unmanned aerial vehicles 110a~110n can replace the one of the unmanned aerial vehicles 110a~110n, which returns for charging, to perform patrol.

In an embodiment, three steps 221~223 can be executed after the step 220; in a step 221, backup power-supply vehicles can be disposed on a patrol area, each of the backup power-supply vehicles obtains a positioning coordinate from the positioning system. In a step 222, when the one of the unmanned aerial vehicles 110a~110n in flight transmits the return-to-home signal but does not receive the coordinate of the power supply vehicle transmitted from the unmanned ground vehicle 120 after a waiting time, the one of the unmanned aerial vehicles 110a~110n in flight broadcasts a charging request. In a step 223, when one of the backup power-supply vehicles receives the charging request, the one of the backup power-supply vehicles can broadcast the positioning coordinate thereof, so that the one of the unmanned aerial vehicles 110a~110n in flight can receive and use the positioning coordinate as the coordinate of the power supply vehicle, and execute the return-to-home program based on the coordinate of the power supply vehicle.

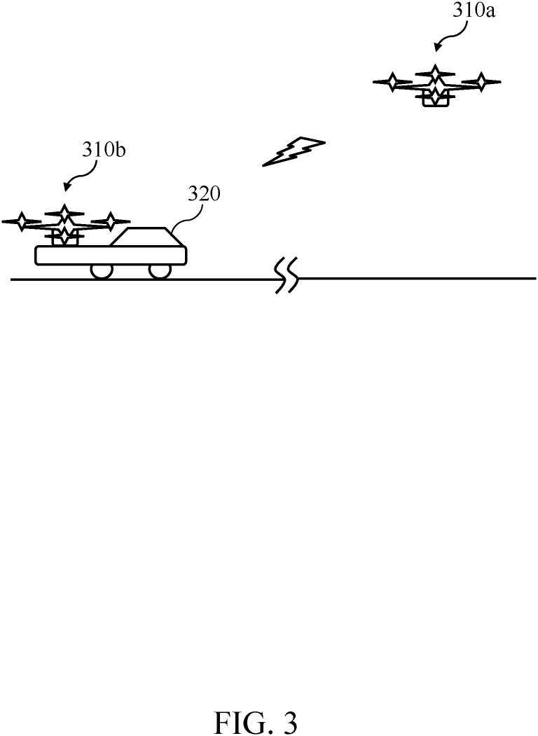

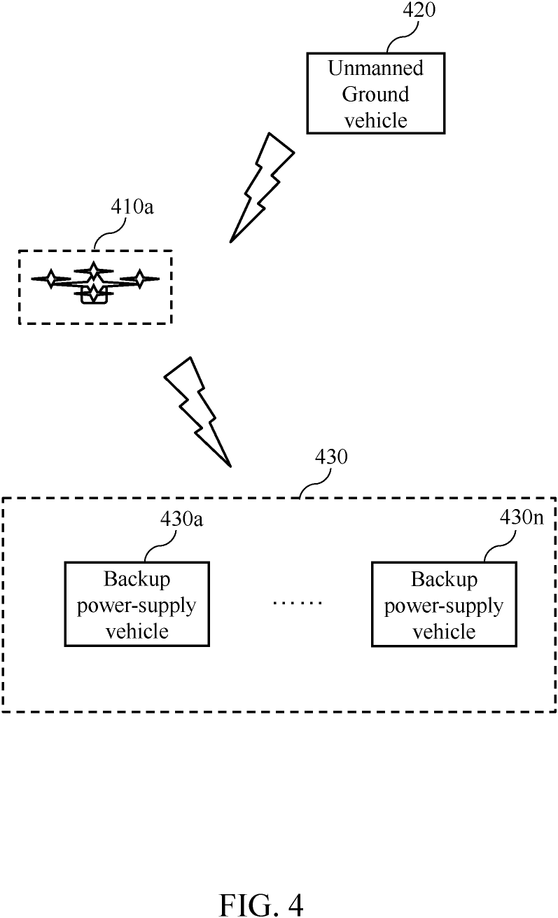

The embodiment of the present invention will be illustrated in the following paragraphs with reference to FIGS. 3 and 4. FIG. 3 is a schematic view of an operation to perform charge and patrol replacement, according to the present invention. In a condition that an unmanned ground vehicle 320 selects an unmanned aerial vehicle 310a to activate, and continuously transmits a control signal to the unmanned aerial vehicle 310a, to control the flight of the unmanned aerial vehicle 310a. In this case, the unmanned aerial vehicle 310a continuously uses a sensor to generate patrol data and continuously detects a remaining battery power thereof, when the remaining battery power is lower than the threshold, the unmanned aerial vehicle 310a generates a return-to-home signal and transmits the return-to-home signal to the unmanned ground vehicle 320. When receiving the return-to-home signal, the unmanned ground vehicle 320 transmits a coordinate of a power supply vehicle having a charging module, to the unmanned aerial vehicle 310a in flight. The power supply vehicle having the charging module can be the unmanned ground vehicle 320 having the charging module, or other power supply vehicle having the charging module, such as a charging pile or a charging platform. Next, the unmanned aerial vehicle 310a executes the return-to-home program based on the received coordinate of the power supply vehicle; in a condition that the power supply vehicle having the charging module is the unmanned ground vehicle 320 only, the return-to-home program calculates a distance between the coordinate of the unmanned aerial vehicle 310a in flight and the coordinate of the unmanned ground vehicle 320, and guides the unmanned aerial vehicle 310a in flight to reach and land on the unmanned ground vehicle 320; in a condition that there is other power supply vehicle having the charging module, the return-to-home program selects the nearest power supply vehicle and guides the unmanned aerial vehicle 310a in flight to reach and land on the nearest power supply vehicle, so that the unmanned aerial vehicle 310a and the charging module of the power supply vehicle can be electrically connected to and charge. When the unmanned ground vehicle 320 detects that the unmanned aerial vehicle 310a is executing the return-to-home program, the unmanned ground vehicle 320 selects and activates another unmanned aerial vehicle 310b, and transmits a control signal to the selected unmanned aerial vehicle 310b and controls the unmanned aerial vehicle 310b to fly, and the unmanned aerial vehicle 310a executing the return-to-home program transmits the patrol data to the unmanned aerial vehicle 310b to complete data synchronization, so that the unmanned aerial vehicle 310b can replace the unmanned aerial vehicle 310a, which is executing the return-to-home program, to perform patrol based on the patrol data. As a result, the operation of the charging and patrol replacement for air-land unmanned vehicles can be completed.

As shown in FIG. 4, which is a schematic view of an operation to move an unmanned aerial vehicle to a backup power-supply vehicle for charging, according to an application of the present invention. In actual implementation, backup power-supply vehicles 430a~430n are disposed on a patrol area 430, each of the backup power-supply vehicles 430a~430n obtains a positioning coordinate thereof from the positioning system. After the unmanned aerial vehicle 410a in flight transmits a return-to-home signal but does not receive a coordinate of a power supply vehicle transmitted by the unmanned ground vehicle 420 after a waiting time (such as one minute), the unmanned aerial vehicle 410a in flight broadcasts a charging request. When receiving the charging request, one of the backup power-supply vehicles 430a~430n broadcasts a positioning coordinate thereof, the unmanned aerial vehicle 410a in flight receives and uses the received positioning coordinate as the coordinate of the power supply vehicle, and executes the return-to-home program based on the received coordinate of the power supply vehicle. In this way, even if the unmanned aerial vehicle 410a in flight fails to obtain the coordinate of the power supply vehicle provided by the unmanned ground vehicle 420, the unmanned aerial vehicle 410a in flight still can reach the nearest one of the backup power-supply vehicles 430a~430n for charging.

According to above-mentioned contents, the difference between the present invention and the conventional technology is that in the present invention, the unmanned aerial vehicle in flight continuously detects the remaining battery power thereof, and when the remaining battery power is lower than the threshold, the unmanned aerial vehicle generates and transmits the return-to-home signal to the unmanned ground vehicle, the unmanned ground vehicle continuously transmits the coordinate of the power supply vehicle to the unmanned aerial vehicle in flight, to guide the unmanned aerial vehicle in flight to return to the power supply vehicle for charging, and the unmanned ground vehicle then activates the another unmanned aerial vehicle to synchronize patrol data with the unmanned aerial vehicle which is returned to charge, so as to replace the returned unmanned aerial vehicle to perform patrol. As a result, the above-mentioned technical solution of the present invention is able to solve the conventional problem, to achieve the technical effect of improving the sustainability and synergy of the air-land unmanned vehicles.

The present invention disclosed herein has been described by means of specific embodiments. However, numerous modifications, variations and enhancements can be made thereto by those skilled in the art without departing from the spirit and scope of the disclosure set forth in the claims.

What is claimed is:

1. A charging and patrol replacement system for air-land unmanned aerial vehicles, comprising:
a plurality of unmanned aerial vehicles, wherein each of the plurality of the unmanned aerial vehicles comprises:
a detection module, wherein when the unmanned aerial vehicle is in flight, the detection module generates patrol data through at least one sensor and continuously detect a remaining battery power thereof, and when the remaining battery power is lower than a threshold, the detection module generates a return-to-home signal;
a transceiver module, connected to the detection module, and configured to transmit the generated patrol data and the return-to-home signal, receive a control signal for controlling the flight of the unmanned aerial vehicle, and receive a coordinate of a power supply vehicle having a charging module;
a navigation module, connected to the transceiver module and configured to execute a return-to-home program based on the coordinate of the power supply vehicle, wherein the return-to-home program is executed to calculate a distance between a coordinate of the unmanned aerial vehicle in flight and the coordinate of the power supply vehicle, and the navigation module guides the unmanned aerial vehicle in flight to reach and land on the power supply vehicle having a shortest distance from the unmanned aerial vehicle in flight, to electrically connect to the charging module for charging; and
a synchronization module, connected to the navigation module, wherein when the unmanned aerial vehicle executes the return-to-home program, the synchronization module transmits the patrol data to another activated unmanned aerial vehicle to complete data synchronization, so that the another activated unmanned aerial vehicle replaces the unmanned aerial vehicle, which is executing the return-to-home program, to perform patrol based on the patrol data; and
an unmanned ground vehicle, comprising:
a control module, configured to generate the control signal for controlling the flight of the unmanned aerial vehicle, and select one of the plurality of unmanned aerial vehicle to activate, wherein when the unmanned ground vehicle detects that the selected one of the unmanned aerial vehicle is executing the return-to-home program, the unmanned ground vehicle selects another one of the plurality of unmanned aerial vehicle to activate; and
a transmission module, connected to the control module and configured to continuously transmit the control signal to the selected unmanned aerial vehicle, wherein when receiving the return-to-home signal from the unmanned aerial vehicle in flight, the transmission module transmits the coordinate of the power supply vehicle to the unmanned aerial vehicle in flight.

2. The charging and patrol replacement system for air-land unmanned aerial vehicles according to claim 1, wherein the unmanned ground vehicle comprises the charging module and a positioning module, and when receiving the return-to-home signal, the unmanned ground vehicle enables the charging module disposed thereon to make the unmanned ground vehicle become the power supply vehicle, and the unmanned ground vehicle obtains the coordinate of the power supply vehicle from the positioning module and continuously transmits to the unmanned aerial vehicle executing the return-to-home program.

3. The charging and patrol replacement system for air-land unmanned aerial vehicles according to claim 1, further comprising a plurality of backup power-supply vehicles, wherein each of the plurality of backup power-supply vehicles is disposed on a patrol area and configured to obtain a positioning coordinate from the positioning system, when the unmanned aerial vehicle in flight transmits the return-to-home signal but does not receive a coordinate of the power supply vehicle transmitted from the unmanned ground vehicle after a waiting time, the unmanned aerial vehicle in flight broadcasts a charging request, and when the backup power-supply vehicle receives the charging request, the backup power-supply vehicle broadcasts the positioning coordinate thereof, so that the unmanned aerial vehicle in flight receives the positioning coordinate as the coordinate of the power supply vehicle, and executes the return-to-home program based on the coordinate of the power supply vehicle.

4. The charging and patrol replacement system for air-land unmanned aerial vehicles according to claim 1, wherein the charging module comprises a wireless charging platform and an automatic landing-guidance system, and when the unmanned aerial vehicle is landing, the unmanned aerial vehicle continuously receives flight parameters transmitted from the automatic landing-guidance system, the unmanned aerial vehicle is guided to align to a central point of the wireless charging platform based on the flight parameters, and a flight posture of the unmanned aerial vehicle is adjusted based on the flight parameters.

5. The charging and patrol replacement system for air-land unmanned aerial vehicles according to claim 1, wherein the charging module comprises a magnetic charging component, when the unmanned aerial vehicle lands on the power supply vehicle, a magnetic connector disposed on a bottom of a mounting frame of the unmanned aerial vehicle is electrically connect to the magnetic charging component for charging.

6. A charging and patrol replacement method for air-land unmanned aerial vehicles, applied to environment where a plurality of unmanned aerial vehicles and an unmanned ground vehicle are disposed, wherein the charging and patrol replacement method comprises:
selecting and activating one of the plurality of unmanned aerial vehicles and continuously transmitting a control signal to the selected unmanned aerial vehicle to control a flight of the selected unmanned aerial vehicle, by the unmanned ground vehicle;
continuously generating patrol data through at least one sensor, continuously detecting a remaining battery power of the unmanned aerial vehicle in flight, and generating and transmitting a return-to-home signal to the unmanned ground vehicle when the remaining battery power is lower than a threshold, by the unmanned aerial vehicle in flight;
when the unmanned ground vehicle receives the return-to-home signal, transmitting a coordinate of a power supply vehicle having a charging module, to the unmanned aerial vehicle in flight;
executing a return-to-home program based on the received coordinate of the power supply vehicle, by the unmanned aerial vehicle in flight, wherein the return-to-home program is executed to calculate a distance between the coordinate of the unmanned aerial vehicle in flight and the coordinate of the power supply vehicle, to guide the unmanned aerial vehicle in flight to reach and land on the power supply vehicle having a shortest distance therefrom, and to electrically connect to the charging module for charging;
when the unmanned ground vehicle detects that the unmanned aerial vehicle is executing the return-to-home program, selecting and activating another one of the unmanned aerial vehicle, and transmitting a control signal to the selected unmanned aerial vehicle to control and select another unmanned aerial vehicle to fly, by the unmanned ground vehicle; and
transmitting the patrol data to the another activated unmanned aerial vehicle to complete data synchronization, by the unmanned aerial vehicle executing the return-to-home program, wherein the another activated unmanned aerial vehicle replaces the unmanned aerial vehicle, which is executing the return-to-home program, to perform patrol based on the patrol data.

7. The charging and patrol replacement method for air-land unmanned aerial vehicles according to claim 6, further comprising:
when the unmanned ground vehicle receives the return-to-home signal, enabling the charging module disposed on the unmanned ground vehicle, to make the unmanned ground vehicle become the power supply vehicle; and
continuously transmitting the coordinate of the power supply vehicle to the unmanned aerial vehicle executing the return-to-home program.

8. The charging and patrol replacement method for air-land unmanned aerial vehicles according to claim 6, further comprising:
disposing backup power-supply vehicles on patrol area, wherein each of the backup power-supply vehicles obtain a positioning coordinate from the positioning system;
when the unmanned aerial vehicle in flight transmits the return-to-home signal but does not receive a coordinate of the power supply vehicle transmitted from the unmanned ground vehicle after a waiting time, broadcasting a charging request, by the unmanned aerial vehicle in flight; and
when the backup power-supply vehicle receives the charging request, broadcasting a positioning coordinate of the backup power-supply vehicle, receiving and using the positioning coordinate as the coordinate of the power supply vehicle, and executing the return-to-home program based on the coordinate of the power supply vehicle, by the unmanned aerial vehicle in flight.

9. The charging and patrol replacement method for air-land unmanned aerial vehicles according to claim 6, wherein the charging module comprises a wireless charging platform and an automatic landing-guidance system, and when the unmanned aerial vehicle is landing, the unmanned aerial vehicle continuously receives flight parameters transmitted from the automatic landing-guidance system, the unmanned aerial vehicle is guided to align to a central point of the wireless charging platform based on the flight parameters, and a flight posture of the unmanned aerial vehicle is adjusted based on the flight parameters.

10. The charging and patrol replacement method for air-land unmanned aerial vehicles according to claim 6, wherein the charging module comprises a magnetic charging component, when the unmanned aerial vehicle lands on the power supply vehicle, a magnetic connector disposed on a bottom of a mounting frame of the unmanned aerial vehicle is electrically connect to the magnetic charging component for charging.
